(19) United States
(12) Patent Application Publication
(10) Pub. No.: US 2021/0026282 A1
(43) Pub. Date: Jan. 28, 2021

(54) Image Forming Device, And Control Method And Control Program Of Image Forming Device

(71) Applicant: Konica Minolta, Inc., Tokyo (JP)

(72) Inventor: Toru KIKUCHI, Tokyo (JP)

(73) Assignee: Konica Minolta, Inc., Tokyo (JP)

(21) Appl. No.: 16/934,232

(22) Filed: Jul. 21, 2020

(30) Foreign Application Priority Data
Jul. 22, 2019 (JP) 2019-134424

(51) Int. Cl. G03G 15/00; G03G 15/20

(52) U.S. Cl. CPC G03G 15/5062; G03G 15/2039; G03G 15/2064

(57) ABSTRACT

An image forming device includes: an image former that forms a toner image on a sheet; a fixer including a fixing member brought into contact with the toner image on the sheet to be heated by a heater, a pressure member brought into pressure contact with the fixing member, and a driver that drives at least any one of the fixing member and the pressure member, and allowing the sheet to pass through a fixing nip formed between the fixing member and the pressure member to fix an unfixed toner on the sheet; and a hardware processor.

The entire disclosure of Japanese patent Application No. 2019-134424, filed on Jul. 22, 2019, is incorporated herein by reference in its entirety.

### BACKGROUND

### Technological Field

The present invention relates to an image forming device, and a control method and a control program of the image forming device.

### Description of the Related Art

There is a need for a fixing device capable of stably fixing a high-quality image on a sheet. In an electrophotographic image forming device, a sheet on which a toner image is formed by an image former is allowed to pass through a fixing nip of a fixing device, and is subjected to a heating/pressurizing process to fix the toner image on the sheet. In a configuration including a fixing belt, for example, the fixing nip is formed between the fixing belt stretched over a heating roller and a fixing roller and a pressure roller, and in a configuration without the fixing belt, this is formed between the fixing roller and the pressure roller.

In association with this, JP 2014-81610-A discloses a technology of preventing a phenomenon that an influence of a preceding fixing step occurs as gloss unevenness (gloss memory) by providing a difference between a moving speed of a pressure roller and a moving speed of a fixing belt to generate a shearing force between an image surface on a sheet and the fixing belt.

JP 2018-97118-A discloses a fixing device that controls gloss of a toner image formed on a recording member (sheet) by controlling rotation of upper and lower pressure rollers so that a difference occurs in drive force between the upper and lower pressure rollers.

However, at the time of double-sided printing, in a case where a toner image formed on a front surface of a sheet is fixed by a fixing device, then a toner image is formed on a rear surface of the sheet, and the toner image on the rear surface is fixed by the fixing device, the toner image on the front surface passes through the fixing device twice in total. Therefore, when fixing the toner image on the rear surface of the sheet, the toner image fixed on the front surface might be melted again, and gloss of the toner image on the front surface might increase. As a result, contrary to user's assumption that the gloss of an output image is at the same level on the front surface and the rear surface, there is a possibility that a difference occurs in the gloss of the output image between the front surface and the rear surface.

### SUMMARY

The present invention is achieved in view of the above-described circumstances, and an object thereof is to provide an image forming device, and a control method and a control program of the image forming device capable of preventing or suppressing a difference in gloss of an output image between a front surface and a rear surface at the time of double-sided printing.

To achieve the abovementioned object, according to an aspect of the present invention, an image forming device reflecting one aspect of the present invention comprises: an image former that forms a toner image on a sheet; a fixer including a fixing member brought into contact with the toner image on the sheet to be heated by a heater, a pressure member brought into pressure contact with the fixing member, and a driver that drives at least any one of the fixing member and the pressure member, and allowing the sheet to pass through a fixing nip formed between the fixing member and the pressure member to fix an unfixed toner on the sheet; and a hardware processor, wherein, in a case where the toner image is fixed on a first surface of the sheet and then the toner image is fixed on a second surface on a side opposite to the first surface by the fixer, the hardware processor controls so that a first speed difference being a difference in moving speed between the fixing member and the pressure member when fixing on the first surface is different from a second speed difference being a difference in moving speed between the fixing member and the pressure member when fixing on the second surface.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic cross-sectional view illustrating a configuration of an image forming device according to a first embodiment;

FIG. 2 is a schematic block diagram illustrating the configuration of the image forming device illustrated in FIG. 1;

FIG. 3 is a schematic diagram illustrating a principal configuration of a fixer illustrated in FIG. 1;

FIG. 4 is an enlarged schematic diagram of a fixing nip in FIG. 3;

FIG. 5 is a flowchart illustrating a procedure of a control method of the image forming device according to a first embodiment;

FIG. 6 is a schematic diagram illustrating a relationship between a difference between a moving speed of a fixing belt and a moving speed of a lower pressure roller and gloss;

FIG. 7A is a schematic diagram for illustrating a principle of gloss control in a case of fixing by performing assist;

FIG. 7B is a schematic diagram for illustrating a principle of gloss control in a case of fixing by performing break;

FIG. 8A is a schematic diagram for illustrating fixing on a front surface of a sheet at the time of double-sided printing;

FIG. 8B is a schematic diagram for illustrating fixing on a rear surface of a sheet at the time of double-sided printing;

FIG. 9 is a view illustrating a transition in fixing temperature in a third embodiment;

FIG. 10 is a schematic diagram illustrating a principal configuration of a fixer according to a fourth embodiment;

FIG. 11 is a schematic diagram illustrating a principal configuration of a fixer according to a fifth embodiment; and

FIG. 12 is a schematic diagram illustrating a fixer and an image reader according to a sixth embodiment.

### DETAILED DESCRIPTION OF EMBODIMENTS

Hereinafter, one or more embodiments of the present invention will be described with reference to the drawings. However, the scope of the invention is not limited to the disclosed embodiments. Note that, in the description of the drawings, the same elements are assigned with the same reference sign, and the description thereof is not repeated. Dimensional ratios of the drawings are exaggerated for convenience of illustration and might differ from actual ratios.

### First Embodiment

<Image Dorming Device 100>

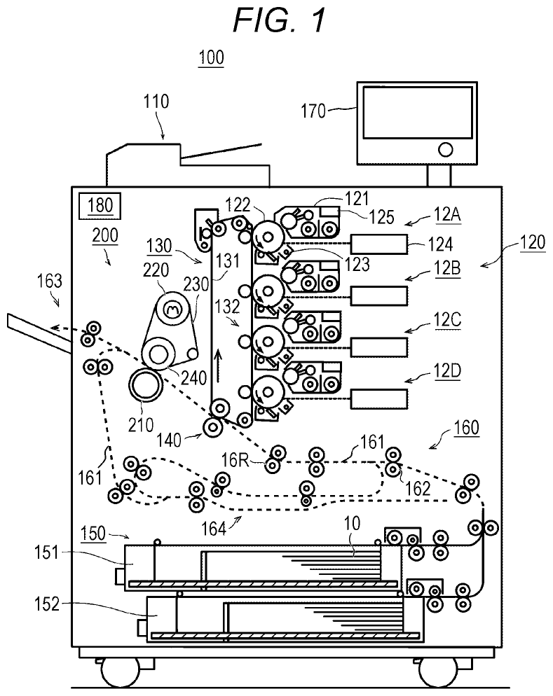

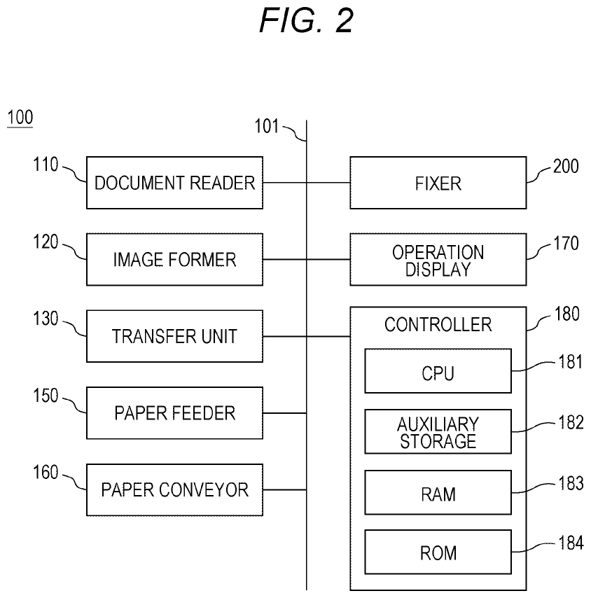

FIG. 1 is a schematic cross-sectional view illustrating a configuration of an image forming device according to a first embodiment, and FIG. 2 is a schematic block diagram illustrating the configuration of the image forming device illustrated in FIG. 1.

An image forming device 100 illustrated in FIG. 1 is an electrophotographic image forming device which uses image data of a scanned document or image data generated based on a print job received from an external client terminal to form (print) an image on sheet 10 as a recording medium. The image forming device 100 may be a multi-function peripheral (MFP) having a copy function, a printer function, and a scanner function, for example.

The image forming device 100 includes a document reader 110, an image former 120, a transfer unit 130, a paper feeder 150, a paper conveyer 160, an operation display 170, a controller 180, and a fixer 200.

The document reader 110 applies light from a light source to a document set in a predetermined reading position on a platen, or a document conveyed to a predetermined reading position by an auto document feeder (ADF), and performs photoelectric conversion on reflected light by a light receiving element such as a CCD image sensor and a CMOS image sensor to generate an electric signal. The generated electric signal is subjected to A/D conversion, shading correction, filter processing, image compression processing and the like and is transmitted to the image former 120.

The image former 120 forms an image on the sheet 10. The image former 120 includes an image forming unit 12A which forms a yellow (Y) image, an image forming unit 12B which forms a magenta (M) image, an image forming unit 12C which forms a cyan (C) image, and an image forming unit 12D which forms a black (K) image.

Each unit of the image former 120 includes a developing device 121, a photoreceptor drum 122, a charger 123, and an optical writer 124.

The developing device 121 visualizes an electrostatic latent image with toner to form a toner image by allowing the toner to adhere to a surface of the photoreceptor drum 122. That is, monochrome toner images corresponding to yellow, magenta, cyan, and black are formed on the photoreceptor drums 122 of the image forming units 12A, 12B, 12C, and 12D, respectively. The developing device 121 of each of the image forming units 12A to 12D contains a two-component developer including toner of a small particle diameter of different colors of yellow, magenta, cyan, and black, respectively, and a carrier.

The photoreceptor drum 122 is an image carrier including a photoreceptor layer formed by using a resin such as polycarbonate including an organic photo conductor (OPC), and is configured to rotate at a predetermined speed. The charger 123 includes a corona discharge electrode arranged around the photoreceptor drum 122, and charges the surface of the photoreceptor drum 122 by generated ions. The optical writer 124 incorporates a scanning optical device, and exposes the charged photoreceptor drum 122 based on the image data, thereby lowering potential of an exposed portion to form a charge pattern (electrostatic latent image) corresponding to the image data.

The transfer unit 130 includes an intermediate transfer belt 131, a primary transfer unit 132, and a secondary transfer unit 140, and transfers the toner image on the photoreceptor drum 122 developed by the developing device 121 to the intermediate transfer belt 131.

The intermediate transfer belt 131 having an endless shape is arranged beside the image forming units 12A to 12D, and is positioned so as to abut the photoreceptor drum 122. The intermediate transfer belt 131 is formed by using, for example, a polyimide film. On the intermediate transfer belt 131, the monochrome toner images of respective colors formed by the image forming units 12A to 12D are sequentially transferred by the primary transfer unit 132, and a color toner image obtained by superimposing forming units layers of yellow, magenta, cyan, and black is formed. The secondary transfer unit 140 transfers the color toner image formed on the intermediate transfer belt 131 to the sheet 10 which is conveyed.

The paper feeder 150 includes a plurality of paper feed trays 151 and 152 for accommodating the sheets 10. The paper feed trays 151 and 152 accommodate, for example, sheets such as plain paper and coated paper for each paper type or paper size. The sheets 10 are sent out to the paper conveyer 160 one by one.

The paper conveyer 160 conveys the sheet 10 in the image forming device 100. The paper conveyer 160 includes a paper conveyance path 161 and a plurality of conveyance roller pairs 162 for conveying the sheet 10. The sheet 10 fed from the paper feeder 150 is conveyed along the paper conveyance path 161 by rotation driving of the plurality of conveyance roller pairs 162 by a driver (motor not illustrated). The sheet 10 is conveyed to the secondary transfer unit 140 via a registration roller 16R, and conveyed to the fixer 200 after the toner image is transferred thereto by the secondary transfer unit 140.

The fixer 200 fixes the toner image transferred to the sheet 10. A configuration of the fixer 200 is described later in detail. The sheet 10 with the toner image fixed on a front surface is discharged from a paper discharger 163 to the outside of the image forming device 100 through the paper conveyance path 161 in a case of single-sided printing, or reversed by a reversing unit 164 of the paper conveyer 160 to be conveyed again to the secondary transfer unit 140 in a case of double-sided printing. Then, the toner image is transferred to a rear surface of the sheet 10 by the secondary transfer unit 140, the toner image on the rear surface is fixed by the fixer 200, and thereafter, the sheet 10 is discharged from the paper discharger 163 to the outside of the image forming device 100.

The operation display 170 receives an instruction of a user and displays a message and the like to the user on a screen. The operation display 170 includes a keyboard and an operation panel. The user inputs the instruction to the image forming device 100 by operating the keyboard or the operation panel. Input information, various types of setting information, a warning message and the like are displayed on the screen.

The controller 180 integrally controls each unit of the document reader 110, the image former 120, the transfer unit 130, the paper feeder 150, the paper conveyer 160, the operation display 170, and the fixer 200 to realize various functions of the image forming device 100.

The controller 180 includes a central processing unit (CPU) 181, an auxiliary storage 182, a random access memory (RAM) 183, and a read only memory (ROM) 184, and the components are connected to one another by an internal bus.

The CPU 181 executes a control program and controls each unit of the image forming device 100. The auxiliary storage 182 stores an operating system, various application programs, the control program and the like.

The RAM 183 temporarily stores a result of arithmetic processing by the CPU 181, the image data and the like. The ROM 184 stores various parameters and the like used by the CPU 181 in the arithmetic processing and the like.

The controller 180 includes a network interface (not illustrated) for communicating with a device such as a client terminal connected to a network, and obtains the print job from the client terminal through the network interface. The print job includes print data and print setting information. The controller 180 serves as an obtainer.

<Fixer 200>

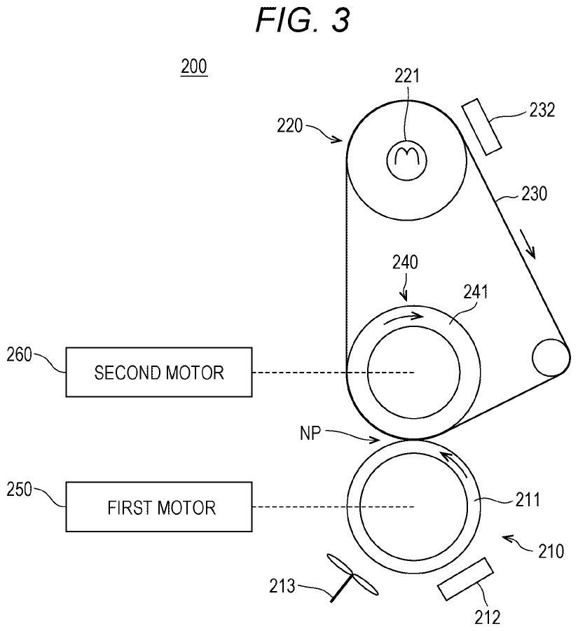

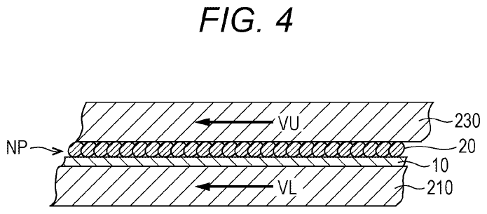

Next, the configuration of the fixer 200 is described in detail with reference to FIG. 3. FIG. 3 is a schematic diagram illustrating a principal configuration of the fixer 200 illustrated in FIG. 1, and FIG. 4 is an enlarged schematic diagram of a fixing nip in FIG. 3.

The fixer 200 is a belt heating type fixer, and includes a lower pressure roller 210, a first temperature sensor 212, a cooling fan 213, a heating roller 220, a fixing belt 230, a second temperature sensor 232, an upper pressure roller 240, a first motor 250, and a second motor 260.

The lower pressure roller 210 is, for example, a roller having an outer diameter of about 80 [mm] obtained by coating a solid metal core formed by using metal such as iron or aluminum with an elastic layer 211. The lower pressure roller 210 serves as a pressure member. As a material of the elastic layer 211, for example, heat-resistant silicone rubber may be used. The silicone rubber is formed to have a thickness of, for example, about 10 [mm], and its hardness may be, for example, JIS-A10 [° ]. The elastic layer 211 may be formed by coating the heat-resistant silicone rubber with a resin layer of a PFA tube as a surface releasing layer. The resin layer of the PFA tube may have Asker C hardness of 30 [°], for example.

The lower pressure roller 210 is connected to the first motor 250 as a driving source. The first motor 250 serves as a driver, and may be, for example, a brushless motor. In this case, the controller 180 controls current flowing through winding of each phase by controlling magnitude and a direction of voltage applied to each phase of U, V, and W of the first motor 250. For current control of the first motor 250, for example, an inverter circuit and a pulse width modulation (PWM) circuit may be used. Note that, the lower pressure roller 210 and the first motor 250 may be connected to each other via a gear. In this embodiment, the lower pressure roller 210 is rotationally driven in an arrow direction (counterclockwise) by the first motor 250 in response to an instruction by the controller 180.

In the vicinity of the lower pressure roller 210, the first temperature sensor 212 (first temperature detector) which detects temperature of an outer peripheral surface of the lower pressure roller 210, and the cooling fan 213 which cools the lower pressure roller 210 are arranged. A detection result of first temperature sensor 212 is transmitted to the controller 180. The cooling fan 213 is controlled to be turned on/off by the controller 180. By cooling the lower pressure roller 210 by the cooling fan 213, the toner of the toner image on the front surface fixed once is suppressed from being melted again at the time of double-sided printing.

The heating roller 220 heats the fixing belt 230. The heating roller 220 is obtained by coating an outer peripheral surface of a cylindrical metal core formed by using aluminum, iron and the like, for example, with a resin layer coated with polytetrafluoroethylene (PTFE) and incorporates a heating source 221 which heats the fixing belt 230. The heating source 221 serves as a heater, and is, for example, a halogen heater (hereinafter, simply referred to as “heater”).

The fixing belt 230 is formed, for example, by coating an outer peripheral surface of a base material formed by using of polyimide having a thickness of 70 [μm] with heat-resistant silicone rubber as an elastic layer, and further coating a surface layer with a perfluoroalkoxy (PFA) tube which is a heat-resistant resin. The fixing belt 230 serves as a fixing member. A thickness of the silicone rubber may be, for example, 400 [μm]. The fixing belt 230 has an outer diameter of, for example, about 168 [mm], and is stretched between the heating roller 220 and the upper pressure roller 240 with a predetermined belt tension (for example, 200 N).

The fixing belt 230 comes into contact with the sheet 10 on which the toner image is formed, and heats the toner image at predetermined fixing temperature to fix. Herein, the fixing temperature is temperature at which an amount of heat required for melting the toner on the sheet 10 may be supplied (for example, 160 to 200 [° C.]) and might vary depending on the paper type and the like of the sheet 10 on which the image is formed.

In the vicinity of the fixing belt 230, the second temperature sensor 232 (second temperature detector) which detects temperature of the fixing belt 230 is arranged. A detection signal by the second temperature sensor 232 is transmitted to the controller 180. The controller 180 calculates the temperature of the fixing belt 230 based on the detection signal by the second temperature sensor 232.

The controller 180 controls to turn on/off power supply to the heater based on the temperature detected by the second temperature sensor 232 so that the temperature of the fixing belt 230 reaches set temperature corresponding to the fixing temperature.

The upper pressure roller 240 is a roller having an outer diameter of about 90 [mm] obtained by coating a solid metal core formed by using metal such as iron or aluminum with an elastic layer 241, for example. As a material of the elastic layer 241, for example, heat-resistant silicone rubber may be used. The silicone rubber is formed to have a thickness of, for example, about 20 [mm], and its hardness may be, for example, JIS-A10 [°]. The elastic layer 241 may be formed by coating the heat-resistant silicone rubber with a resin layer of a PFA tube as a surface releasing layer. The resin layer of the PFA tube may have Asker C hardness of 35 [°], for example.

The upper pressure roller 240 is connected to the second motor 260 as a driving source. The second motor 260 serving as a driver has a configuration similar to that of the first motor 250, and a rotational speed thereof is controlled by the controller 180. Note that, the upper pressure roller 240 and the second motor 260 may be connected via a gear. In this embodiment, the upper pressure roller 240 is rotationally driven in an arrow direction (clockwise) by the second motor 260 in response to an instruction by the controller 180.

The controller 180 drives at least any one of the lower pressure roller 210 and the upper pressure roller 240 (fixing belt 230) as a driving member by the driver, and controls so that a surface of the lower pressure roller 210 and a surface of the fixing belt 230 move.

The lower pressure roller 210 is brought into pressure contact with the upper pressure roller 240 via the fixing belt 230 with a predetermined fixing load (for example, 2500 [N]). In this manner, a fixing nip NP which holds the sheet 10 to convey is formed between the fixing belt 230 and the lower pressure roller 210.

The fixer 200 fixes an unfixed toner image on the sheet 10 by conveying the sheet 10 while heating and pressurizing the same by the fixing nip NP. For example, at the time of normal fixing, the lower pressure roller 210 and the upper pressure roller 240 are driven, and fixing is performed at a predetermined fixing conveyance speed. The predetermined fixing conveyance speed is set according to a system speed in general. The system speed is a speed related to image formation, and corresponds to, for example, a rotational speed and the like of the intermediate transfer belt 131 (refer to FIG. 1). The predetermined fixing conveyance speed may be set, for example, to 300 to 600 [mm/s].

The controller 180 drives the lower pressure roller 210 as the driving member for conveying the sheet 10, for example, and controls driving of the upper pressure roller 240 by the second motor 260 so that the fixing belt 230 moves following the movement of the lower pressure roller 210. For example, as illustrated in FIG. 4, the surface of the lower pressure roller 210 moves at a speed of VL in an arrow direction at the fixing nip NP, and the surface of the fixing belt 230 similarly moves at a speed of VU in an arrow direction. In this case, a moving speed (peripheral speed) of the fixing belt 230 is slightly lower than a moving speed (peripheral speed) of the lower pressure roller 210 (that is, VU<VL). In this specification, a state in which one of the fixing member 230 and the lower pressure roller 210 moves following the other is referred to as a “reference state”.

Note that, it is also possible that the controller 180 drives the lower pressure roller 210 as the driving member and does not transmit torque from the second motor 260 to the upper pressure roller 240, thereby controlling so that the fixing belt 230 moves following the movement of the lower pressure roller 210.

The toner image includes a large number of toner particles 20 stacked on the sheet 10 in one or a plurality of layers. FIG. 4 illustrates a case where one layer of the toner particles 20 is formed for simplifying the illustration; however, the toner layer including a plurality of layers is generally formed by a large number of toner particles 20.

Each toner particle 20 has a spherical shape in an unfixed state. When the toner particle 20 is fixed by the fixer 200, this is stretched by a small shearing force due to a difference between the moving speed of the fixing belt 230 and the moving speed of the lower pressure roller 210 (hereinafter, simply referred to as “difference in moving speed”) to be deformed, and fused to the surface of the sheet 10. When the toner particles 20 are deformed, they exhibit gloss according to an amount of deformation.

The gloss of the toner image might change depending on the fixing temperature (temperature of the fixing belt 230), a fixing load, the temperature of the lower pressure roller 210 and the like in addition to the deformation of the toner particles 20 at the time of fixing.

<Control Method of Image Forming Device 100>

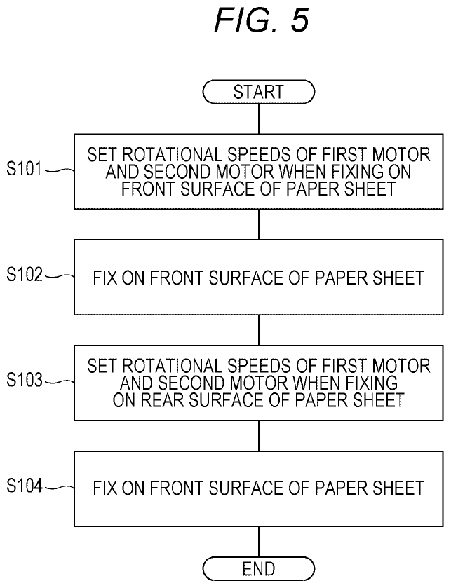

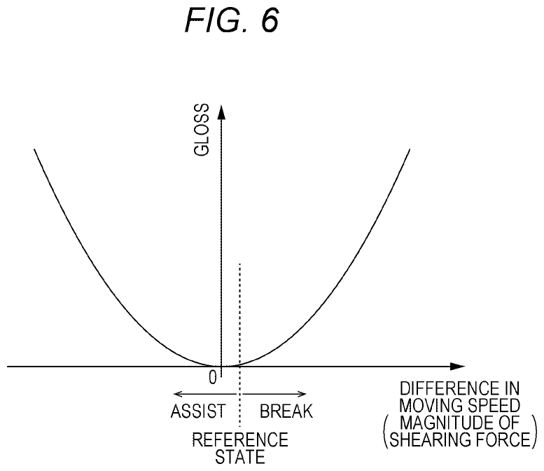

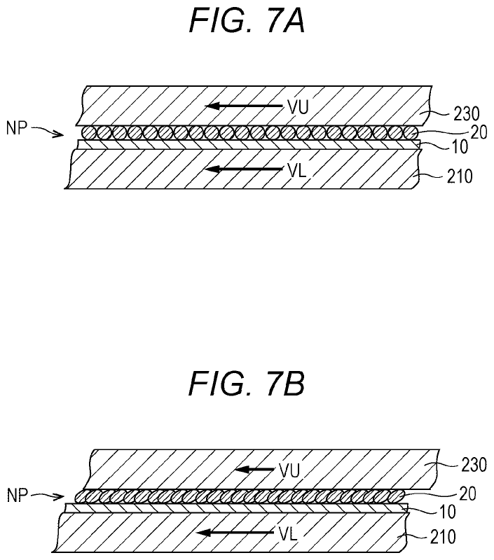

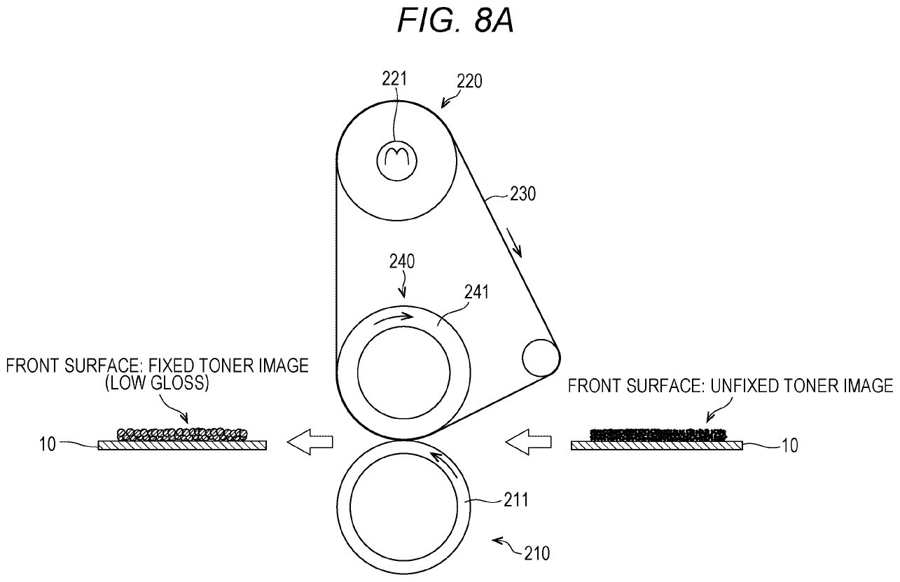

FIG. 5 is a flowchart illustrating a procedure of a control method of the image forming device 100 according to the first embodiment. Each process in the flowchart illustrated in FIG. 5 is realized when the CPU 181 of the controller 180 executes the control program. FIG. 6 is a schematic diagram illustrating a relationship between the difference in moving speed and the gloss. FIG. 7A is a schematic diagram for illustrating a principle of gloss control in a case of fixing by performing assist, and FIG. 7B is a schematic diagram for illustrating a principle of gloss control in a case of fixing by performing brake. In this specification, control of the moving speed of the fixing belt 230 to be higher than the moving speed of the fixing belt 230 in the reference state by driving the second motor 260 to assist the movement of the fixing belt 230 is referred to as “assist”. Control of the moving speed of the fixing belt 230 to be lower than the moving speed of the fixing belt 230 in the reference state is referred to as “brake”. FIG. 8A is a schematic diagram for illustrating the fixing on the front surface of the sheet at the time double-sided printing, and FIG. 8B is a schematic diagram for illustrating the fixing on the rear surface of the sheet at the time of double-sided printing.

First, an outline of the control of the image forming device 100 is described. As described above, in the fixer 200, after fixing on the front surface (first surface) of the sheet 10, when fixing on the rear surface (second surface) which is the opposite surface, the lower pressure roller 210 is cooled by the cooling fan 213 so that the toner of the toner image fixed on the front surface does not reach melting temperature again.

However, for example, in a case where the number of sheets to be printed is large and the sheets continuously pass through the fixer 200, opportunities that the lower pressure roller 210 and the fixing belt 230 are brought into pressure contact with each other increases, so that heat transferred from the fixing belt 230 to the lower pressure roller 210 increases. As a result, the temperature of the lower pressure roller 210 increases, and depending on a sheet passing condition, the toner of the toner image fixed on the front surface of the sheet 10 might reach the melting temperature.

For example, in early or late stages of sheet passing to the fixer 200, an interval between sheets is sometimes large. In a case where an operation of each unit of the image forming device 100 is adjusted also, the interval between the sheets is sometimes large. When the interval between the sheets increases, a time period in which the fixing belt 230 and the lower pressure roller 210 are brought into direct contact with each other increases, so that the heat transmitted from the fixing belt 230 to the lower pressure roller 210 further increases.

Therefore, it is not possible to sufficiently suppress an increase in temperature of the lower pressure roller 210 only by cooling by the cooling fan 213, and the toner of the toner image fixed on the front surface of the sheet 10 might reach the melting temperature. As a result, the gloss of the toner image fixed on the front surface of the sheet 10 increases, and there is a possibility that the gloss differs between the toner images fixed on the front and rear surfaces of the sheet 10.

Therefore, in this embodiment, in the fixing of the toner image on the front surface, the gloss control is performed so that the gloss decreases as compared to that at the time of fixing in the reference state while predicting that the gloss of the toner image fixed on the front surface increases when the toner image is fixed on the rear surface of the sheet 10.

When fixing the toner image on the rear surface of the sheet 10, the gloss control is performed in consideration of an increase in gloss of the toner image fixed on the front surface.

For example, in a case where the increase in gloss on the front surface is predicted not to be small, the controller 180 performs the gloss control so that the gloss increases as compared to that at the time of fixing in the reference state when the toner image is fixed on the rear surface.

In contrast, in a case where it is predicted that the increase in gloss on the front surface when fixing on the rear surface is small and the toner image fixed on the front surface maintains low gloss after fixing on the rear surface, the controller 180 may perform the gloss control so that the gloss decreases as compared to that at the time of fixing in the reference state when fixing the toner image on the rear surface, for example.

In this embodiment, magnitude of the shearing force applied to the toner particles 20 of the toner image on the sheet 10 is adjusted to control the gloss of the toner image fixed on the sheet 10 is controlled. More specifically, the controller 180 controls the first motor 250 and the second motor 260 to adjust the difference in moving speed, thereby adjusting the shearing force to be applied to the toner particles 20.

Note that, the gloss control performed by adjusting the magnitude of the shearing force to be applied to the toner particles 20 is effective only to the unfixed toner image. Therefore, at the time of double-sided printing, even when the shearing force is applied to the toner particles 20 of the toner image fixed on the front surface when fixing on the rear surface of the sheet, there is little change in gloss.

Hereinafter, the procedure of the control method of the image forming device 100 is specifically described. First, as illustrated in FIG. 5, the rotational speeds of the first motor 250 and the second motor 260 (hereinafter, simply referred to as “rotational speeds of the first and second motors”) when fixing on the front surface of the sheet 10 are set (step S101).

At the time of fixing in the reference state, a case is assumed where it is predicted that the gloss of the toner image fixed on the front surface increases by fixing on the rear surface to achieve high gloss. The controller 180 sets the rotational speeds of the first and second motors so that the difference in moving speed (first speed difference) becomes small when fixing on the front surface of the sheet 10. More specifically, in addition to moving the lower pressure roller 210 by driving the first motor 250, the controller 180 drives the second motor 260 to speed up the movement of the upper pressure roller 240 (fixing belt 230) to adjust to decrease the difference in moving speed.

As illustrated in FIG. 6, the gloss increases as the difference in moving speed increases, and decreases as the difference decreases. In a case of fixing by performing assist, the gloss control is performed in a region where the difference in moving speed is smaller than the difference in moving speed in the reference state.

Table 1 illustrates a setting example of the rotational speeds of the first and second motors in a case of fixing by performing assist. Table 1 illustrates speed ratios with respect to different basis weights for coated paper and uncoated paper other than the coated paper such as plain paper. Here, the speed ratio (the same applies to each of following tables) is a ratio of the moving speed of the upper pressure roller 240 (fixing belt 230) by the second motor 260 to the moving speed of the lower pressure roller 210 by the first motor 250. Note that, although the case where the state in which one of the fixing member 230 and the lower pressure roller 210 moves following the other is the reference state is described above, for simplifying the illustration, Table 1 illustrates a value of the speed ratio by making a case where the difference in moving speed is 0, that is, the speed ratio is 1 the reference state. The reference state is not limited to the case where the speed ratio is 1 (the same applies to each of following tables).

In Table 1, the difference in moving speed is smaller as the speed ratio is closer to 1, and the difference in moving speed is larger as the speed ratio is larger than 1 or smaller than 1. In general, the coated paper has a larger heat capacity and is less likely to have higher gloss than the uncoated paper, so that in this embodiment, the speed ratio of the coated paper is set to be the same as or slightly larger than the speed ratio of the uncoated paper. Since the heat capacity of the sheet generally increases as the basis weight increases, in this embodiment, the speed ratio is set so that the difference in moving speed becomes larger, that is, the speed ratio is farther from 1 as the basis weight increases.

TABLE 1

| | |
|---|---|
| Basis weight | Speed ratio |

| [gsm] | Uncoated paper | Coated paper |
|---|---|---|
| to 79 | 1.01 | 1.01 |
| 80 to 100 | 1.02 | 1.02 |
| 101 to 177 | 1.02 | 1.03 |
| 178 to 299 | 1.03 | 1.03 |
| 300 to 400 | 1.03 | 1.04 |
| 400 to 500 | 1.03 | 1.05 |

The controller 180 obtains the paper type (for example, coated paper/uncoated paper), the basis weight and the like of the sheet 10 from the print setting information (sheet information), and determines the speed ratio from Table 1, for example, according to the obtained paper type and basis weight. An assist amount corresponds to an amount obtained by subtracting the speed ratio 1 in the reference state from the determined speed ratio. For example, the rotational speeds of the first and second motors at the time assist are calculated based on the predetermined fixing conveyance speed and the determined speed ratio.

Next, the fixing on the front surface of the sheet 10 is performed (step S102). The controller 180 conveys the sheet 10 to the fixing nip NP with the front surface facing upward, and allows the sheet 10 to pass through the fixing nip NP with the front surface of the sheet 10 facing a fixing surface of the fixing belt 230. As illustrated in FIG. 7A, in a case where the difference in moving speed is small, that is, the speed ratio is close to 1, the shearing force applied to the toner particles 20 becomes small. Therefore, an amount of deformation of the toner particles 20 decreases, and unevenness of the toner image due to the toner particles 20 is maintained. As a result, as illustrated in FIG. 8A, the gloss of the fixed toner image on the front surface is lower than the gloss in a case where this is fixed in the reference state.

Next, the rotational speeds of the first and second motors when fixing on the rear surface of the sheet 10 are set (step S103). In a case where it is predicted that the gloss of the toner image fixed on the front surface increases by the fixing on the rear surface, the gloss of the toner image on the rear surface may be increased when fixing on the rear surface in consideration of the increase in gloss on the front surface. In this case, the controller 180 sets the rotational speeds of the first and second motors so that a difference in moving speed at the time of fixing on the rear surface (second speed difference) increases.

More specifically, the controller 180 controls the moving speed of the fixing belt 230 to be lower than the moving speed of the fixing belt 230 in the reference state by decreasing the rotational speed of the second motor 260. As a result, the difference in moving speed increases.

As illustrated in FIG. 6, in a case of fixing by braking, the gloss control is performed in a region in which the difference in moving speed is larger than the difference in moving speed in the reference state.

Table 2 illustrates a setting example of the rotational speeds of the first and second motors in a case of fixing by performing brake. Table 2 illustrates speed ratios with respect to different basis weights for coated paper and uncoated paper. A relationship between a difference in paper type and the speed ratio and a relationship between the basis weight and the speed ratio are similar to those in Table 1.

[Table 2

| | |
|---|---|
| Basis weight | Speed ratio |

| [gsm] | Uncoated paper | Coated paper |
|---|---|---|
| to 79 | 0.99 | 0.99 |
| 80 to 100 | 0.99 | 0.98 |
| 101 to 177 | 0.98 | 0.98 |
| 178 to 299 | 0.97 | 0.97 |
| 300 to 400 | 0.97 | 0.96 |

The controller 180 determines the speed ratio from Table 2, for example, according to the paper type and the basis weight of the sheet 10. A break amount corresponds to an amount obtained by subtracting the determined speed ratio from the speed ratio 1 in the reference state. For example, the rotational speeds of the first and second motors at the time of break are calculated based on the predetermined fixing conveyance speed and the determined speed ratio.

Next, the fixing on the rear surface of the sheet 10 is performed (step S104). The controller 180 controls to reverse the sheet 10 on the front surface of which the toner image is fixed and form the toner image on the rear surface. Then, the controller 180 conveys the sheet 10 to the fixing nip NP with the rear surface facing upward, and allows the sheet 10 to pass through the fixing nip NP with the rear surface of the sheet 10 facing the fixing surface of the fixing belt 230.

As illustrated in FIG. 7B, since the difference in moving speed becomes large, the shearing force applied to the toner particles 20 of the toner image becomes large. Therefore, the amount of deformation of the toner particles 20 increases, and the toner particles 20 are stretched, so that the gloss of the toner image increases. As a result, as illustrated in FIG. 8B, the gloss of the fixed toner image on the rear surface becomes higher than the gloss in a case of fixing in the reference state. The toner image on the front surface is heated again at the time of fixing on the rear surface, so that the gloss of the toner image increases. Therefore, the gloss of the toner image on the front surface is approximately the same as that on the rear surface because the increase in gloss at the time of fixing on the rear surface is added to low gloss at the time of fixing on the front surface.

In contrast, in a case where the toner image fixed on the front surface is predicted to maintain low gloss even after the toner image is fixed on the rear surface, the controller 180 performs the gloss control to realize low gloss also for fixing of the toner image on the rear surface. In this case, the controller 180 sets the rotational speeds of the first and second motors so that the difference in moving speed (second speed difference) decreases. In order to make the difference in moving speed of the front surface and the rear surface different and to take into account the increase in gloss on the front surface, the assist amount when fixing on the rear surface may be set smaller than the assist amount when fixing on the front surface.

In this manner, in this embodiment, it is possible to make the gloss of the toner image lower than that at the time of fixing in the reference state (low gloss control) by making the difference in moving speed smaller than that at the time of fixing in the reference state to fix. It is also possible to make the gloss of the toner image higher than that at the time of fixing in the reference state (high gloss control) by making the difference in moving speed larger than that at the time of fixing in the reference state to fix. Therefore, by making the difference in moving speed between the front and rear surfaces of the sheet 10 different at the time of double-sided printing, it is possible to appropriately determine the gloss of the toner image on the rear surface according to the predicted increase in gloss of the toner image on the front surface, so that it is possible to prevent or suppress the difference in gloss of the output image between the front and rear surfaces.

Note that, in the above-described example, a case where the difference in moving speed is decreased when fixing the toner image on the front surface of the sheet 10 is described; however, the present invention is not limited to such a case. It is also possible to set so as to increase the difference in moving speed when fixing on the front surface and the rear surface. For example, the controller 180 may control to perform brake when fixing the toner image on the front surface and perform brake with a larger brake amount than that of the front surface when fixing the toner image on the rear surface.

### Second Embodiment

In a second embodiment, a case where a difference in moving speed is set according to temperature of a lower pressure roller 210 is described. Note that, in order to avoid repetition of description, the same configuration as that in the first embodiment is not described.

In a case where the temperature of the lower pressure roller 210 is high when fixing on a front surface of a sheet 10, an increase in gloss of a toner image on the front surface is predicted. Therefore, in this embodiment, in order to suppress the increase in gloss of the toner image on the front surface, an assist amount is increased according to the temperature of the lower pressure roller 210 when fixing on the front surface.

More specifically, for example, in a case where the temperature of the lower pressure roller 210 is higher than predetermined temperature, a controller 180 sets rotational speeds of first and second motors so that a speed ratio becomes larger than 1. In contrast, in a case where the temperature of the lower pressure roller 210 is lower than the predetermined temperature, the speed ratio is maintained at 1. In a case where the temperature of the lower pressure roller 210 is higher than the predetermined temperature, the rotational speeds of the first and second motors are set so that the speed ratio increases as the temperature of the lower pressure roller 210 increases.

Table 3 is a table illustrating the speed ratio according to a basis weight and the temperature of the lower pressure roller 210 in a case where a paper type is uncoated paper. For example, in a case where the basis weight is 79 [gsm] or smaller, the predetermined temperature is 90 [° C.].

TABLE 3

| Basis | Speed ratio | | | | | | | |
|---|---|---|---|---|---|---|---|---|
| weight | Temperature of lower pressure roller [° C.] | | | | | | | |
| [gsm] | to 59 | 60 to 69 | 70 to 79 | 80 to 89 | 90 to 99 | 100 to 109 | 110 to 119 | from 120 |
| to 79 | 1 | 1 | 1 | 1 | 1.02 | 1.03 | 1.03 | 1.04 |
| 80 to 100 | 1 | 1 | 1.01 | 1.01 | 1.02 | 1.03 | 1.03 | 1.04 |
| 101 to 177 | 1 | 1 | 1.01 | 1.01 | 1.02 | 1.03 | 1.04 | 1.04 |
| 178 to 299 | 1 | 1 | 1.01 | 1.01 | 1.02 | 1.03 | 1.04 | 1.04 |
| 300 to 400 | 1 | 1 | 1.01 | 1.01 | 1.03 | 1.04 | 1.04 | 1.05 |
| 400 to 500 | 1 | 1 | 1.01 | 1.01 | 1.03 | 1.05 | 1.05 | 1.06 |

Following Table 4 is a table illustrating the speed ratio according to the basis weight and the temperature of the lower pressure roller 210 in a case where the paper type is coated paper.

TABLE 4

| Basis | Speed ratio | | | | | | | |
|---|---|---|---|---|---|---|---|---|
| weight | Temperature of lower pressure roller [° C.] | | | | | | | |
| [gsm] | to 59 | 60 to 69 | 70 to 79 | 80 to 89 | 90 to 99 | 100 to 109 | 110 to 119 | from 120 |
| to 79 | 1 | 1 | 1 | 1.02 | 1.03 | 1.03 | 1.04 | 1.04 |
| 80 to 100 | 1 | 1 | 1.01 | 1.02 | 1.03 | 1.03 | 1.04 | 1.04 |
| 101 to 177 | 1 | 1 | 1.01 | 1.02 | 1.03 | 1.04 | 1.04 | 1.04 |
| 178 to 299 | 1 | 1 | 1.01 | 1.02 | 1.03 | 1.04 | 1.04 | 1.05 |
| 300 to 400 | 1 | 1 | 1.01 | 1.03 | 1.04 | 1.04 | 1.05 | 1.06 |
| 400 to 500 | 1 | 1 | 1.01 | 1.03 | 1.05 | 1.05 | 1.06 | 1.06 |

In a case where the temperature of the lower pressure roller 210 is high when fixing on a rear surface of the sheet 10, it is considered that the gloss of the toner image on the front surface increases due to heat of the lower pressure roller 210. In consideration of the increase in gloss of the toner image on the front surface, a break amount may be increased according to the temperature of the lower pressure roller 210 when fixing on the rear surface.

More specifically, for example, in a case where the temperature of the lower pressure roller 210 is higher than the predetermined temperature, the controller 180 sets the rotational speeds of the first and second motors so that the speed ratio becomes smaller than 1. In contrast, in a case where the temperature of the lower pressure roller 210 is lower than the predetermined temperature, the speed ratio is maintained at 1. In a case where the temperature of the lower pressure roller 210 is higher than the predetermined temperature, the rotational speeds of the first and second motors are set so that the speed ratio decreases as the temperature of the lower pressure roller 210 increases.

The controller 180 calculates the temperature of the lower pressure roller 210 based on a detection result of a first temperature sensor 212 in a case of fixing on the front surface or rear surface of the sheet 10, and determines the speed ratio according to the temperature of the lower pressure roller 210. Then, the controller 180 calculates an assist amount or a brake amount from a reference state.

In this manner, in this embodiment, since the difference in moving speed is set according to the temperature of the lower pressure roller 210, even if the temperature of the lower pressure roller 210 fluctuates, occurrence of fluctuation in gloss of the fixed toner image may be suppressed.

Note that, although a case where the difference in moving speed is set according to the temperature of the lower pressure roller 210 for both the front surface and rear surface of the sheet 10 is described, the present invention is not limited to such a case. It is also possible to configure to set the difference in moving speed according to the temperature of the lower pressure roller 210 for either the front surface or rear surface.

### Third Embodiment

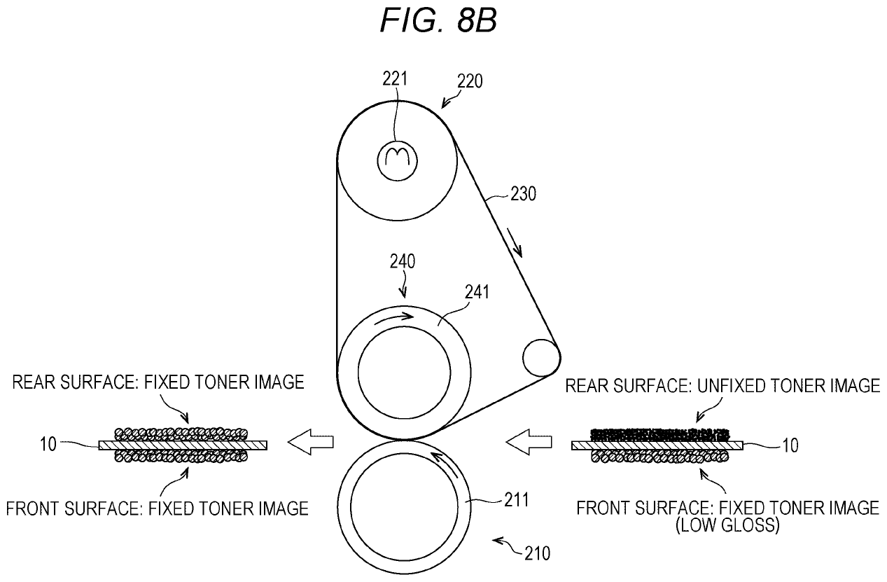

In a third embodiment, a case where fluctuation in gloss of a toner image associated with fluctuation in fixing temperature is considered is described. FIG. 9 is a view illustrating a transition in fixing temperature in the third embodiment. Note that, in order to avoid repetition of description, the same configuration as that in the first embodiment is not described.

As described above, a controller 180 controls to turn on/off power supply to a heater of a heating source 221 based on temperature detected by a second temperature sensor 232 so that temperature of a fixing belt 230 reaches set temperature corresponding to fixing temperature. However, as illustrated in FIG. 9, actual temperature of the fixing belt 230 changes with a delay from the on/off control of the controller 180. For example, after the heater is turned on in 24 seconds, the temperature of the fixing belt 230 reaches the set temperature in 40 seconds after a delay of 16 seconds. Therefore, the temperature of the fixing belt 230 has a fluctuation range VA from a minimum value to a maximum value. As a result, gloss of a fixed toner image also fluctuates according to the fluctuation of the temperature of the fixing belt 230.

Therefore, in this embodiment, a difference in moving speed is set for front and rear surfaces of the sheet 10 according to the temperature of the fixing belt 230 in consideration of the fluctuation in gloss of the toner image associated with the fluctuation in temperature of the fixing belt 230. Following table 5 is a table illustrating an offset from an original speed ratio in a case where a basis weight and a difference from the set temperature of the fixing belt 230 are changed. Note that, the setting of the speed ratio illustrated in Table 5 is applicable to both the front surface and the rear surface of the sheet 10.

TABLE 5

| | Speed ratio | | | | |
|---|---|---|---|---|---|
| Basis weight | Difference from set temperature of fixing belt [° C.] | | | | |
| [gsm] | −20° C. | −10° C. | ±0 | +10° C. | +20° C. |
| to 79 | −0.03 | −0.02 | No change | +0.03 | +0.04 |
| 80 to 100 | −0.03 | −0.02 | No change | +0.03 | +0.04 |
| 101 to 177 | −0.03 | −0.02 | No change | +0.03 | +0.04 |
| 178 to 299 | −0.03 | −0.02 | No change | +0.03 | +0.04 |
| 300 to 400 | −0.03 | −0.02 | No change | +0.03 | +0.04 |
| 400 to 500 | −0.03 | −0.02 | No change | +0.03 | +0.04 |

For example, the controller 180 makes the speed ratio of a predetermined fixing conveyance speed an original speed ratio, and adds an offset to the original speed ratio in accordance with a value of the basis weight and a difference value from the set temperature of the fixing belt 230 to determine a new speed ratio. In Table 5, a positive offset corresponds to a case of performing assist, and a negative offset corresponds to a case of performing brake. In the example illustrated in Table 5, in a case where the difference from the set temperature of the fixing belt 230 is a negative value, that is, the temperature of the fixing belt 230 is lower than the set temperature, the gloss is predicted to decrease, and the break is performed to fix so as to maintain the gloss constant. In a case where the difference from the set temperature of the fixing belt 230 is a positive value, that is, the temperature of the fixing belt 230 is higher than the set temperature, it is predicted that the gloss increases, so that assist is performed to fix so as to maintain the glass constant.

The controller 180 calculates, for example, a rotational speed which realizes a determined new speed ratio based on the predetermined fixing conveyance speed, and determines an assist amount or a brake amount from a reference state.

In the example illustrated in FIG. 9, a period in which the temperature of the fixing belt 230 becomes higher or lower than the set temperature delays by about half a cycle as compared to turning on/off of the heater. Therefore, as for a period in which the temperature of the fixing belt 230 is lower than the set temperature after the heater is turned on, the negative offset may be added, and as for a period in which the temperature of the fixing belt 230 is higher than the set temperature after the heater is turned off, the positive offset may be added. That is, the controller 180 determines the assist amount or the brake amount from the reference state according to the timing at which the heater is turned on/off. In this manner, by adjusting the assist amount or the brake amount, effective gloss control may be performed. Therefore, for example, immediately after an image forming device 100 is started in the morning, in a case where the fixing belt 230 is not sufficiently warmed or the like, it is possible to suppress the gloss of the fixed toner image from fluctuating even in a case where the fixing temperature fluctuates significantly.

In this manner, in this embodiment, the difference in moving speed is set according to the temperature of the fixing belt 230. Also, a timing at which assist or brake is performed is adjusted in consideration of a change in temperature of the fixing belt 230 after turning on/off the heater. Therefore, even if the temperature of the fixing belt 230 fluctuates, it is possible to suppress fluctuation of the gloss of the fixed toner image.

### Fourth Embodiment

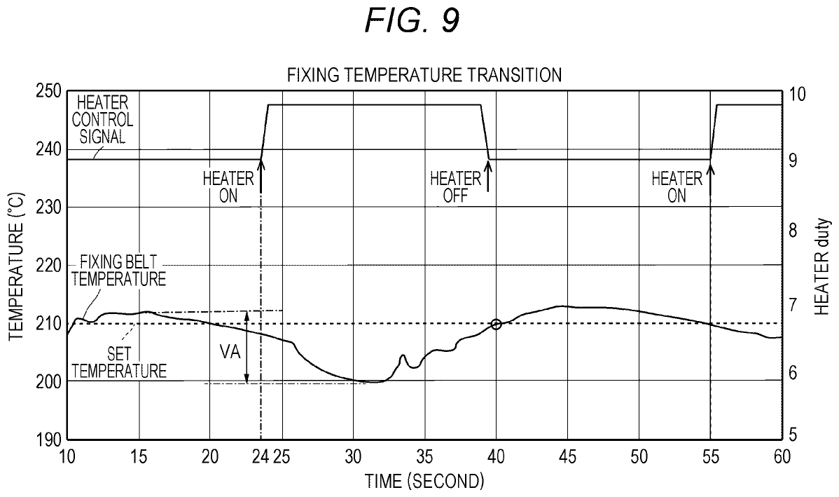

In a fourth embodiment, a case is described where fluctuation in gloss of a toner image due to slip of a sheet 10 at a fixing nip NP is considered. FIG. 10 is a schematic diagram illustrating a principal configuration of a fixer according to the fourth embodiment. Note that, in order to avoid repetition of description, the same configuration as that in the first embodiment is not described.

As illustrated in FIG. 10, a fixer 200 further includes a paper detecting sensor 270. Note that, a first temperature sensor, a cooling fan, and a first motor of a lower pressure roller 210, and a second motor of an upper pressure roller 240 are not illustrated.

The paper detecting sensor 270 is arranged in the vicinity of a paper conveyance path 291 in the fixer 200 to detect a leading edge and a trailing edge of the sheet 10 conveyed on the paper conveyance path 291 after fixing. The paper detecting sensor 270 may be, for example, a reflection-type or transmission-type optical sensor. The controller 180 calculates a conveyance speed (substantially equal to a fixing conveyance speed) of the sheet 10 immediately after the fixing delivered from a fixing nip NP based on a time from when the leading edge of the sheet 10 is detected to when the trailing edge is detected, and a length of the sheet 10 in a conveyance direction. The paper detecting sensor 270 and the controller 180 serve as a conveyance speed measurer.

At the fixing nip NP, the sheet 10 sometimes slips with respect to a fixing belt 230 due to melted toner. When the sheet 10 slips, a shearing force is applied to toner particles 20 of a toner image, so that the gloss of the toner image increases. Since the sheet 10 slips, the fixing conveyance speed becomes lower than a system speed. In this embodiment, the system speed is, for example, about 300 to 600 [mm/s].

Following table 6 is a table illustrating an offset from an original speed ratio in a case where a difference between the fixing conveyance speed and the system speed is changed for each of front and rear surfaces of the sheet.

TABLE 6

| Difference between fixing | |
|---|---|
| conveyance speed and system | Speed ratio |

| speed | Front surface | Rear surface |
|---|---|---|
| −1.5% | +0.05 | +0.02 |
| −1.0% | +0.04 | +0.01 |
| −0.5% | +0.03 | No change |
| +0.5% | No change | −0.01 |
| +1.0% | −0.01 | −0.02 |
| +1.5% | −0.02 | −0.03 |

For example, the controller 180 makes a speed ratio of a predetermined fixing conveyance speed an original speed ratio, adds the offset to the original speed ratio in accordance with a difference value between the fixing conveyance speed and the system speed, and determines a new speed ratio. The determined new speed ratio is applied to a subsequent sheet. In Table 6, a positive offset corresponds to a case where assist is performed, and a negative offset corresponds to a case where brake is performed.

The controller 180 calculates, for example, a rotational speed which realizes a determined new speed ratio based on the predetermined fixing conveyance speed, and determines an assist amount or a brake amount from a reference state.

In the example illustrated in Table 6, as for the front surface of the sheet, in a case where the difference between the fixing conveyance speed and the system speed is a negative value, that is, in a case where slip occurs and the fixing conveyance speed is lower than the system speed, it is predicted that the gloss increases. In this case, in order to maintain the gloss constant, the controller 180 performs assist according to the difference to fix gloss. Since this is the front surface, an offset amount may be set slightly larger.

As for the front surface, in a case where the difference between the fixing conveyance speed and the system speed is a positive value, that is, in a case where the fixing conveyance speed is higher than the system speed, it is predicted that the gloss slightly decreases. In this case, in order to maintain the gloss constant, the controller 180 fixes without changing the difference in moving speed in a case where the difference is relatively small (+0.5%). In a case where an absolute value of the difference exceeds 0.5%, braking is performed according to the difference to fix.

Also, as for the rear surface of the sheet, in a case where the difference between the fixing conveyance speed and the system speed is a negative value, that is, in a case where slip occurs and the fixing conveyance speed is lower than the system speed, it is predicted that the gloss increases. In this case, in order to maintain the gloss constant, the controller 180 fixes without changing the difference in moving speed in a case where the absolute value of the difference is relatively small (−0.5%). In a case where the absolute value of the difference exceeds 0.5%, the assist is performed according to the difference to fix. Since this is the rear surface, the offset amount may be set to be smaller.

In contrast, as for the rear surface of the sheet, in a case where the difference between the fixing conveyance speed and the system speed is a positive value, that is, in a case where the fixing conveyance speed is higher than the system speed, it is predicted that the gloss decreases, so that the braking is performed according to the difference to fix in order to maintain the gloss constant.

In this manner, in this embodiment, since the difference in moving speed is set according to the difference between the fixing conveyance speed and the system speed, even when the sheet 10 slips at the fixing nip NP, it is possible to suppress fluctuation of the gloss of the fixed toner image.

### Fifth Embodiment

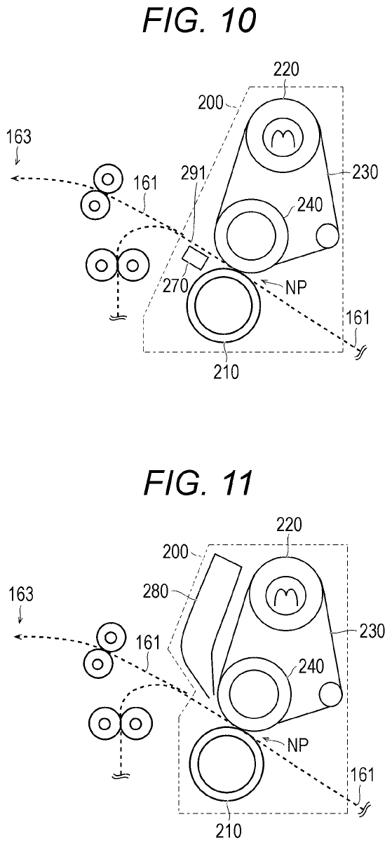

In a fifth embodiment, a case is described where a difference in moving speed is set according to a rotational speed of a fixing/separating fan 280. FIG. 11 is a schematic diagram illustrating a principal configuration of a fixer according to the fifth embodiment. Note that, in order to avoid repetition of description, the same configuration as that in the first embodiment is not described.

As illustrated in FIG. 11, a fixer 200 further includes the fixing/separating fan 280. Note that, a first temperature sensor, a cooling fan, and a first motor of a lower pressure roller 210, and a second motor of an upper pressure roller 240 are not illustrated.

The fixing/separating fan 280 is arranged on a subsequent stage of a fixing nip NP and separates a sheet 10 from a fixing belt 230 by blowing air to a leading edge of the sheet 10 which passes through the fixing nip NP. By this, it is possible to prevent occurrence of jam (winding jam) and the like because the sheet 10 which passes through the fixing nip NP winds around a surface of the fixing belt 230 and is not separated. A rotational speed of the fixing/separating fan is set (changed) according to a basis weight and a paper type, and is feedback-controlled to an optimum rotational speed. For example, the rotational speed of the fixing/separating fan is set to be higher (that is, a wind amount is larger) as the sheet is thinner, and as for coated paper, this is set to be higher than that of uncoated paper.

Ease of separation (separability) when the sheet 10 is separated from the fixing belt 230 differs depending on conditions such as a printing rate of the sheet 10, environmental humidity and the like, for example. There is a correlation between the separability of the fixed sheet and the gloss of the toner image, and the lower the separability, the more the sheet winds around the fixing belt 230, so that the higher the gloss. In contrast, the higher the separability, the less the sheet winds around the fixing belt 230, so that the gloss is stabilized in a low state.

Following table 7 is a table illustrating an offset from an original speed ratio in a case where a difference between the rotational speed (output) of the fixing/separating fan and a reference rotational speed is changed for each of front and rear surfaces of the sheet. The reference rotational speed is set for each sheet 10 according to, for example, the printing rate, environmental humidity and the like.

TABLE 7

| | |
|---|---|
| Difference between rotational | |
| speed of fixing/separating fan and | Speed ratio |

| reference rotational speed | Front surface | Rear surface |
|---|---|---|
| −15% | +0.05 | +0.02 |
| −10% | +0.04 | +0.01 |
| −5% | +0.03 | +0.01 |
| +5% | No change | −0.01 |
| +10% | No change | −0.02 |
| +15% | No change | −0.03 |

For example, the controller 180 makes a speed ratio of a predetermined fixing conveyance speed the original speed ratio and adds the offset to the original speed ratio in accordance with the difference between the rotational speed of the fixing/separating fan 280 and the reference rotational speed, thereby determining a new speed ratio. In Table 7, a positive offset corresponds to a case of performing assist, and a negative offset corresponds to a case of performing brake.

The controller 180 calculates, for example, a rotational speed which realizes a determined new speed ratio based on the predetermined fixing conveyance speed, and determines an assist amount or a brake amount from a reference state.

In the example illustrated in Table 7, as for the front surface of the sheet, in a case where the difference between the rotational speed of the fixing/separating fan 280 and the reference rotational speed is a negative value, that is, in a case where the rotational speed of the separating fan is lower than the reference rotational speed, the sheet is less likely to be separated, so that it is predicted that the gloss becomes high. In this case, in order to maintain the gloss constant, the controller 180 performs assist according to the difference to fix gloss. As for the front surface of the sheet, in a case where the difference between the rotational speed of the fixing/separating fan 280 and the reference rotational speed is a positive value, that is, in a case where the rotational speed of the separating fan is higher than the reference rotational speed, the sheet is easily separated, so that it is predicted that the gloss slightly decreases. However, since the gloss of the toner image fixed on the front surface of the sheet is predicted to increase at the time of fixing on the rear surface, the controller 180 fixes without changing the difference in moving speed.

As for the rear surface of the sheet, in a case where the difference between the rotational speed of the fixing/separating fan 280 and the reference rotational speed is a negative value, that is, in a case where the rotational speed of the fixing/separating fan 280 is lower than the reference rotational speed, it is predicted that the gloss becomes high. In this case, in order to maintain the gloss constant, the controller 180 performs assist according to the difference to fix. As for the rear surface of the sheet, in a case where the difference between the rotational speed of the fixing/separating fan 280 and the reference rotational speed is a positive value, that is, in a case where the rotational speed of the fixing/separating fan 280 is higher than the reference rotational speed, it is predicted that the gloss becomes low. In this case, in order to maintain the gloss constant, the controller 180 performs break according to the difference to fix.

In this manner, the controller 180 controls to perform brake/assist in accordance with the rotational speed of the fixing/separating fan 280 for each sheet passing through the fixing nip NP, thereby realizing more accurate gloss control.

### Sixth Embodiment

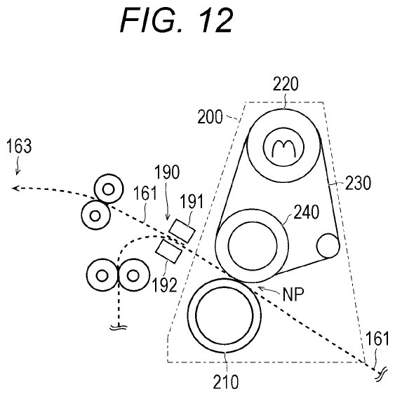

In a sixth embodiment, a case is described where a difference in moving speed is set according to a measurement result of glossiness of a fixed toner image. FIG. 12 is a schematic diagram illustrating a fixer and an image reader according to the sixth embodiment. Note that, in order to avoid repetitive description, the same configuration as that in the first embodiment is not described.

As illustrated in FIG. 12, an image forming device 100 further includes an image reader 190. Note that, a first temperature sensor, a cooling fan, and a first motor of a lower pressure roller 210, and a second motor of an upper pressure roller 240 are not illustrated.

The image reader 190 reads a fixed image (output image) of a sheet 10. The image reader 190 is installed in the middle of a paper conveyance path 161 from a fixing nip NP to a paper discharge tray of the paper discharger 163. The image reader 190 includes a first in-line sensor 191 and a second in-line sensor 192 as a part of an automatic quality optimizing unit (ICCU). The first in-line sensor 191 is installed above the paper conveyance path 161 and reads an output image formed on an upper surface of the sheet 10 conveyed through the paper conveyance path 161. In contrast, the second in-line sensor 192 is installed below the paper conveyance path 161 and reads an output image formed on a lower surface of the sheet 10 conveyed through the paper conveyance path 161. As a result, the output images on the upper surface (front surface) and the lower surface (rear surface) of the sheet 10 may be detected in one-pass (at one time).

As the first and second in-line sensors 191 and 192, a line sensor including a light emitting unit and a plurality of photoelectric conversion elements arranged at a predetermined interval in a sheet width direction (a direction orthogonal to a paper conveyance direction), or photoelectric conversion elements arranged in a matrix shape may be used. Each photoelectric conversion element outputs a signal corresponding to intensity of light emitted from a light source and reflected by a surface of the sheet 10. More specifically, the first and second in-line sensors 191 and 192 apply light at a predetermined incident angle from the light source to the surface of the sheet 10 in a case of measuring the glossiness of the output image, detects the light reflected at a reflection angle the same as the incident angel of the light, and outputs the signal corresponding to the intensity of the detected light. The predetermined incident angle and reflection angle are, for example, 60 degrees. As the line sensor and the image sensor, a CCD sensor or a CMOS sensor (including a MOS sensor) may be used.

The first and second in-line sensors 191 and 192 transmit read image data obtained by reading the output image of the sheet 10 to the controller 180 by serial communication or the like. The controller 180 obtains information on the glossiness (for example, 60-degree glossiness) of the images formed on the front surface and the rear surface of the sheet 10 based on the read image supplied from the image reader 190.

The controller 180 controls to read the fixed output images on the front and rear surfaces of the sheet 10 by the image reader 190 and calculates the glossiness of the output image based on the read image supplied from the image reader 190. The controller 180 and the image reader 190 serve as a glossiness measurer. Then, the controller 180 sets a difference in moving speed based on the glossiness of the output image.

More specifically, in a case where the glossiness of the output image is higher than a predetermined value, +0.01 is added as an offset to an original speed ratio, and a subsequent sheet is subjected to assist to perform fixing. The glossiness of the fixed toner image is measured again, and in a case where the glossiness is high, +0.01 is further added as the offset to the speed ratio, and the subsequent sheet is subjected to assist to perform fixing. Conversely, in a case where the glossiness of the fixed toner image is lower than the predetermined value, −0.01 is added as the offset, and the subsequent sheet is subjected to brake to perform fixing.

The controller 180 calculates, for example, a rotational speed which realizes a determined new speed ratio based on the predetermined fixing conveyance speed, and determines an assist amount or a brake amount from a reference state.

In this manner, in this embodiment, since the difference in moving speed is set according to the measurement result of the glossiness of the fixed toner image, it is possible to realize appropriate gloss to the toner images on the front and rear surfaces of the sheet 10 by setting an appropriate brake/assist amount.

As described above, the image forming device 100 and the control method and the control program of the image forming device 100 are described in the embodiments. However, it goes without saying that those skilled in the art may appropriately add, modify, and omit the present invention within the scope of the technical idea.

For example, in the first to sixth embodiments, the case where the fixer 200 employs a belt heating method is described, but the present invention is not limited to such case. The fixer of the present invention may employ a roller heating method in which the fixing nip is formed between the fixing roller and the pressure roller, and the surface of the fixing roller serves as a fixing surface.

In the first to sixth embodiments, the case where the lower pressure roller 210 conveys the sheet 10 as the driving member in the fixer 200 is described, but the present invention is not limited to such case, and it is also possible that the fixing belt 230 conveys the sheet 10 as the driving member.

Also, the difference in moving speed when fixing on the front surface and the difference in moving speed when fixing on the rear surface may be set independently, or may be set so as to have a certain relationship.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming device comprising:
an image former, wherein the image former forms a toner image on a sheet;
a fixer including
a fixing member, a pressure member, and a driver, wherein
the fixing member is brought into contact with the toner image on the sheet and the fixing member is heated by a heater,
the pressure member is brought into pressure contact with the fixing member,
the driver drives at least any one of the fixing member and the pressure member, and
the fixer allows the sheet to pass through a fixing nip formed between the fixing
member and the pressure member to fix an unfixed toner on the sheet;
a processor; and
a memory including instructions that, when executed by the processor, cause the image forming device to:
set a first speed difference when the toner image is fixed, by the fixer, on a first surface of the sheet to be different from a second speed difference when the toner image is fixed, by the fixer, on a second surface of the sheet opposite to the first surface of the sheet, wherein
the first speed difference is a difference in moving speed between the fixing member and the pressure member when the toner image is fixed on the first surface, and
the second speed difference is as difference in moving speed between the fixing member and the pressure member when the toner image is fixed on the second surface.

2. The image forming device according to claim 1, wherein the instructions are further configured to cause the system to:
perform an assist or perform a break, wherein,
with respect to a reference state in which a first member of the fixing member and the pressure member moves following a second member of the fixing member and the pressure member,
the assist increases a moving speed of the first member, and
the break decreases the moving speed of the first member.

3. The image forming device according to claim 2, wherein the instructions are further configured to cause the system to:
perform the assist when fixing the toner image on the first surface, and
perform the break when fixing the toner image on the second surface.

4. The image forming device according to claim 2, wherein the instructions are further configured to cause the system to:
perform the assist when fixing the toner image on the first surface, wherein
the assist is performed with a first assist amount when fixing the toner image on the first surface,
the assist is performed with a second assist amount when fixing the toner image on the second surface, and
the first assist amount is smaller than the second assist amount.

5. The image forming device according to claim 2, wherein the instructions are further configured to cause the system to:
perform the break when fixing the toner image on the first surface, wherein
the break is performed with a first break amount when fixing the toner image on the first surface,
the break is performed with a second break amount when fixing the toner image on the second surface, and
the first break amount is smaller than the second break amount.

6. The image forming device according to claim 3, further comprising:
an obtainer that obtains sheet information of the sheet,
wherein the assist is performed with an assist amount according to sheet information of the sheet and the break is performed with a break amount according to the sheet information of the sheet.

7. The image forming device according to claim 3, further comprising:
a temperature detector that detects temperature of the pressure member,
wherein the assist is performed with an assist amount according to the detected temperature of the pressure member and the break is performed with a break amount according to the detected temperature of the pressure member.

8. The image forming device according to claim 3, further comprising:
a temperature detector that detects temperature of the fixing member,
wherein the assist is performed with an assist amount according to the detected temperature of the fixing member and the break is performed with a break amount according to the detected temperature of the fixing member.

9. The image forming device according to claim 3,
wherein the assist is performed with an assist amount according to a timing at which the heater heats the fixing member and the break is performed with a break amount according to the timing at which the heater heats the fixing member.

10. The image forming device according to claim 3, further comprising:
a conveyance speed measurer that measures a conveyance speed immediately after the sheet is fixed,
wherein the assist is performed for a second sheet subsequent to the sheet with an assist amount based on the measured conveyance speed and the break is performed for the second sheet with a break amount based on the measured conveyance speed.

11. The image forming device according to claim 3, further comprising:
a fixing/separating fan that separates the sheet from the fixing member by blowing air,
wherein the assist is performed with an assist amount based on an output of the fixing/separating fan and the break is performed with a break amount based on the output of the fixing/separating fan.

12. The image forming device according to claim 3, further comprising:
a glossiness measurer arranged downstream of the fixer in a conveyance direction of the sheet that reads an output image of the sheet fixed by the fixer and measures a glossiness of the output image,
wherein the assist is performed with an assist amount based on the measured glossiness and the break is performed with a break amount based on the measured glossiness.

13. The image forming device according to claim 3, wherein the instructions are further configured to cause the system to:
perform, by performing the assist, low gloss control to decrease a second gloss of the fixed toner image from a first gloss of the toner image at the time of fixing in the reference state by performing the assist.

14. The image forming device according to claim 3, wherein the instructions are further configured to cause the system to:
perform, by performing the break, high gloss control to increase a second gloss of the fixed toner image from a first gloss of the toner image at the time of fixing in the reference state.

15. A control method of an image forming device including:
forming, by an image former, a toner image on a sheet;
bringing, by a fixer, a fixing member into contact with the toner image on the sheet to be heated by a heater;
bringing a pressure member into pressure contact with the fixing member;
driving, by a driver, at least any one of the fixing member and the pressure member, wherein the fixer allows the sheet to pass through a fixing nip formed between the fixing member and the pressure member to fix an unfixed toner on the sheet;
setting a first difference in moving speed between the fixing member and the pressure member to a first speed difference and fixing the toner image on a first surface of the sheet; and
setting a second difference in moving speed between the fixing member and the pressure member to a second speed difference and fixing the toner image on a second surface on a side opposite to the first surface, wherein the second speed difference is different from the first speed difference.

16. A computer program product comprising:
a computer-readable storage medium; and
instructions stored on the computer-readable storage medium that, when executed by a processor, causes the processor to:
form, by an image former, a toner image on a sheet;
bring, by a fixer, a fixing member into contact with the toner image on the sheet to be heated by a heater;
bring a pressure member into pressure contact with the fixing member;
drive, by a driver, at least any one of the fixing member and the pressure member, wherein the fixer allows the sheet to pass through a fixing nip formed between the fixing member and the pressure member to fix an unfixed toner on the sheet;
set a first difference in moving speed between the fixing member and the pressure member to a first speed difference and fixing the toner image on a first surface of the sheet; and
set a second difference in moving speed between the fixing member and the pressure member to a second speed difference and fix the toner image on a second surface on a side opposite to the first surface, wherein the second speed difference is different from the first speed difference.
